(19) United States
(12) Patent Application Publication
(10) Pub. No.: US 2011/0037994 A1
(43) Pub. Date: Feb. 17, 2011

(54) IMAGE FORMING APPARATUS AND IMAGE FORMING METHOD

(75) Inventor: Masaaki Sei, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/850,824

(22) Filed: Aug. 5, 2010

Related U.S. Application Data
(60) Provisional application No. 61/232,856, filed on Aug. 11, 2009.

(51) Int. Cl. G06K 15/00

(52) U.S. Cl. 358/1.14

(57) ABSTRACT

According to one embodiment, an image forming apparatus includes a data collecting unit configured to collect, every time each kind of processing of the apparatus is executed by a task, information related to the processing and store the information in a volatile memory, an error detecting unit configured to detect an error during the processing, a determining unit configured to determine whether the error detected by the error detecting unit is an investigation target error, a target-information selecting unit configured to select, if the determining unit determines that the error is the investigation target error, storage target information out of information for investigation stored in the volatile memory including individual information representing processing content for each of tasks and common information representing processing contents among plural tasks, and a storing unit configured to store the target information in the nonvolatile memory.

### CROSS-REFERENCE TO RELATED APPLICATION

This application is based upon and claims the benefit of U.S. Provisional Application No. 61/232,856, filed on Aug. 11, 2009; the entire contents of which are incorporated herein by reference.

### FIELD

Embodiments described herein relate generally to an image forming apparatus and an image forming method.

### BACKGROUND

After delivering a product to a user, it is important to collect information concerning abnormality that occurs in the product. It is possible to execute appropriate maintenance by analyzing the information concerning the abnormality. Further, it is possible to provide users with better products by feeding back an analysis result to design.

An image forming apparatus (MFP: Multi Function Peripheral) is known that stores, when abnormality occurs, information concerning a state of the occurrence of the abnormality and a cause of a failure in a memory.

However, it is not always possible to acquire desired information concerning the state of the occurrence of the abnormality and the cause of the failure.

For example, the abnormality includes an error of a type that can be eliminated by a user. Therefore, if the information concerning the abnormality is stored in a DRAM, which is a volatile memory, after a deficiency occurs, the information at the time when the abnormality occurs is erased when the user turns off and on a power supply.

There is an upper limit in a capacity of a memory for information storage of an image forming apparatus. Therefore, if the user eliminates an error and continues to use a product, in some case, desired information is erased or only a part of the information remains.

Therefore, it is demanded that, when abnormality occurs, information concerning the occurred abnormality is surely acquired even if a serviceperson does not immediately visit a user of an image forming apparatus in which the abnormality occurs to check the image forming apparatus and collect information.

### BRIEF DESCRIPTION OF THE DRAWINGS

FIG. 1 is an exemplary schematic perspective view of a shape of an image forming apparatus according to an embodiment;

FIG. 2 is an exemplary block diagram of the configuration of a copy function of a MFP according to the embodiment;

FIG. 3 is an exemplary block diagram of the configuration of a control system for the MFP according to the embodiment;

FIG. 4 is an exemplary external view of an operation panel provided in the MFP according to the embodiment;

FIG. 5 is an exemplary flowchart for explaining processing for storing information for investigation acquired when an error occurs according to the embodiment;

FIG. 6 is an exemplary diagram of contents of individual information according to the embodiment;

FIG. 7 is an exemplary diagram of contents of common information according to the embodiment;

FIG. 8 is an exemplary diagram for explaining an operation for copying information from a DRAM to a HDD according to the embodiment;

FIG. 9 is an exemplary schematic system diagram of a maintenance method for the MFP according to the embodiment;

FIG. 10 is an exemplary flowchart for explaining a procedure for collecting information for investigation stored in the HDD by a serviceperson according to the embodiment; and

FIG. 11 is an exemplary diagram of a code input screen according to the embodiment.

### DETAILED DESCRIPTION

In general, according to one embodiment, an image forming apparatus includes: a data collecting unit configured to collect, every time each kind of processing of the apparatus is executed by a task, information related to the processing and store the information in a volatile memory; an error detecting unit configured to detect an error during the processing; a determining unit configured to determine whether the error detected by the error detecting unit is an investigation target error; a target-information selecting unit configured to select, if the determining unit determines that the error is the investigation target error, storage target information out of information for investigation stored in the volatile memory including individual information representing processing content for each of tasks and common information representing processing contents among plural tasks; and a storing unit configured to copy the selected target information to a nonvolatile memory and store the target information in the nonvolatile memory.

Embodiment are explained below with an image forming apparatus (MFP: Multi Function Peripheral) 201 as an example.

The MFP 201 is a digital complex machine for not only scanning to read and copy an image at designated resolution and in a designated sheet size but also comprehensively utilizing various functions of office equipment such as an image receiving function by facsimile, an image receiving function by e-mail, and a printed-image receiving function by a network.

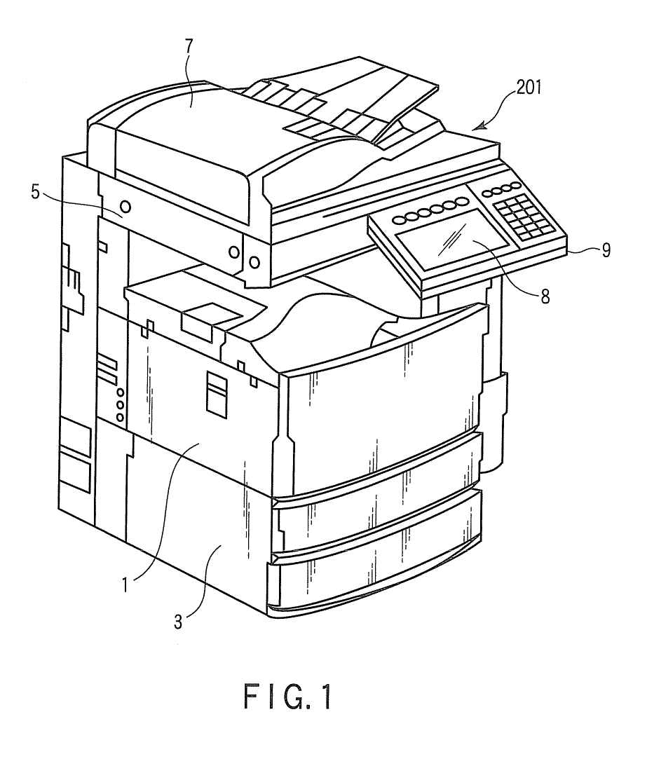

FIG. 1 is an exemplary schematic perspective view of a shape of an image forming apparatus according to an embodiment.

The MFP 201 includes a print unit 1, a sheet tray 3, a scan unit 5, an auto feed unit 7, and an operation panel 9 including a display unit 8.

The print unit 1 outputs image information as an output image called, for example, hardcopy or printout. The sheet tray 3 supplies output media, which are sheets of arbitrary sizes used for image output, to the print unit 1. The scan unit 5 captures image information from an original document as image data. The auto feed unit 7 delivers the original document, for which reading is finished, from a reading position to a discharge position and guides the next original document to the reading position. The operation panel 9 is an instruction input unit for instructing operations of the MFP 201 such as the start of image formation in the print unit 1 and the start of reading of image information of an original document by the scan unit 5. The display unit 8 for inputting an instruction and displaying information to an operator is provided on the operation panel 9.

The MFP 201 can be connected to a network or a communication line to receive image data by facsimile or e-mail.

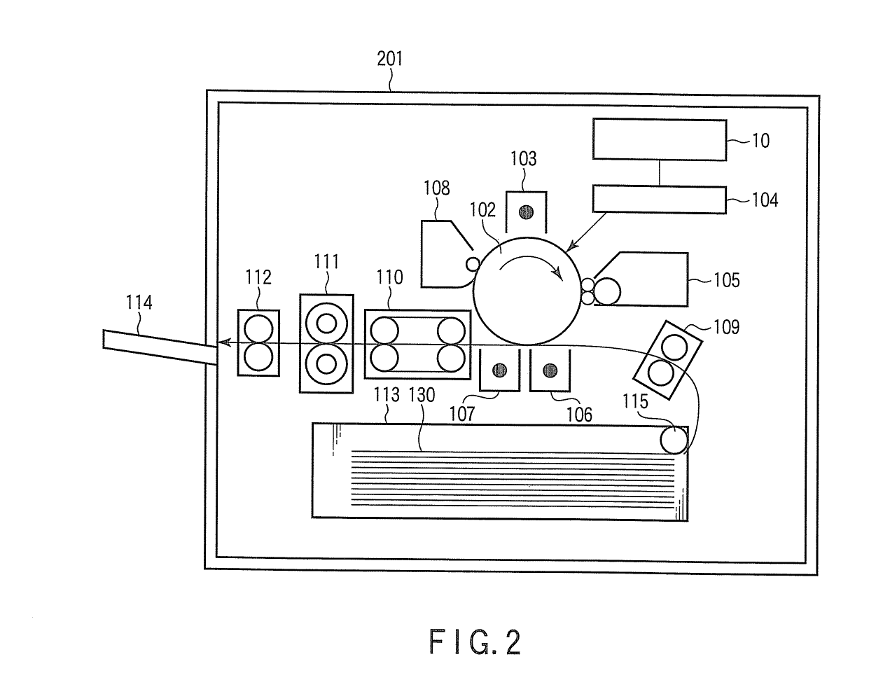

FIG. 2 is an exemplary block diagram of the configuration of a copy function of the MFP according to this embodiment.

The MFP 201 includes a control unit 10, a photoconductive drum 102, a charging device 103, a scanning and exposing unit 104, a developing device 105, a transfer charger 106, a peeling charger 107, a cleaner 108, a paper feeding unit 109, a sheet conveying unit 110, a fixing device 111, a paper discharge unit 112, and a paper discharge tray 114.

The photoconductive drum 102 rotates in a sub-scanning direction, which is a circumferential direction of the photoconductive drum 102. The charging device 103 is arranged near the photoconductive drum 102. The charging device 103 uniformly charges the surface of the photoconductive drum 102. The scanning and exposing unit 104 emits light and extinguishes light according to an image signal while scanning a semiconductor laser in the scanning and exposing unit 104. A laser beam emitted from the semiconductor laser is changed to light for scanning in a main scanning direction, which is a rotation axis direction of the photoconductive drum 102, by a deflector such as a polygon mirror. The laser beam is irradiated on the photoconductive drum 102 by an optical system such as a lens. When the laser beam is irradiated on the charged photoconductive drum 102, the potential in an irradiated region falls and an electrostatic latent image is formed.

The developing device 105 applies a developer to the photoconductive drum 102 to form a toner image on the photoconductive drum 102. The sheet tray 3 is provided in a bottom section of the MFP 201. A paper feeding roller 115 separates sheets 130 in the sheet tray 3 one by one and delivers the sheet 130 to the paper feeding unit 109. The paper feeding unit 109 feeds the sheet 130 to a transfer position of the photoconductive drum 102. The transfer charger 106 transfers the toner image onto the fed sheet 130. The peeling charger 107 peels the sheet 130 from the photoconductive drum 102.

The sheet 130 having the toner image transferred thereon is conveyed by the sheet conveying unit 110. The fixing device 111 fixes the toner image on the sheet 130. The paper discharge unit 112 discharges the sheet 130 having an image printed thereon to the paper discharge tray 114.

After the transfer of the toner image onto the sheet 130 ends, a residual toner on the photoconductive drum 102 is removed by the cleaner 108. The photoconductive drum 102 returns to an initial state and stays on standby for the next image formation.

The image forming operation is continuously performed by repeating the process operation explained above.

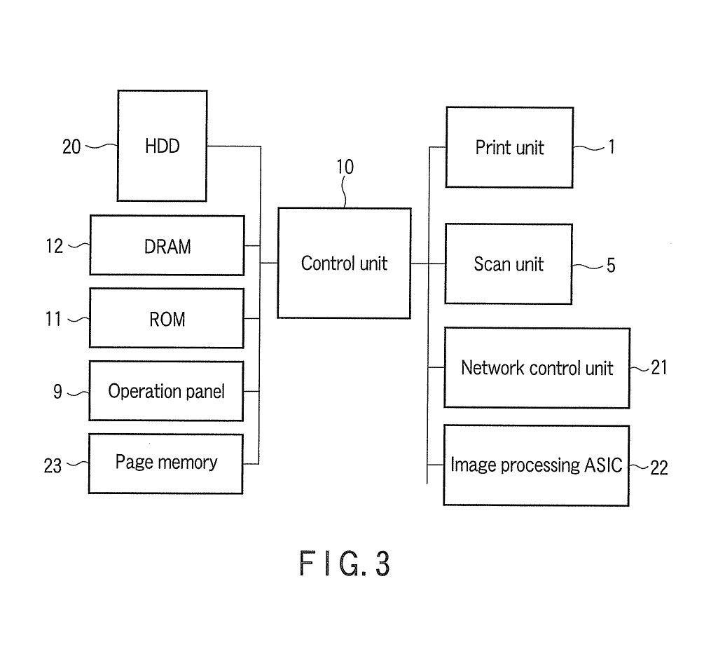

FIG. 3 is an exemplary block diagram of the configuration of a control system for the MFP 201 according to this embodiment.

The MFP 201 further includes, together with the print unit 1, the sheet tray 3, the scan unit 5, the display unit 8, the operation panel 9, and the control unit 10, a ROM 11, a DRAM 12, an internal storage device (HDD) 20, a network control unit 21, an image processing ASIC 22, and a page memory 23. These units are connected to one another via a system bus.

The control unit 10 controls the units of hardware connected via the system bus. The ROM 11 has stored therein various control programs necessary for the MFP 201 to operate. Computer programs for treating information concerning abnormality explained later are stored in the ROM 11. Execution of the computer programs is controlled by the control unit 10. The DRAM 12 is a buffer memory configured to temporarily store data generated during the execution of the computer programs. The DRAM 12 is a volatile memory. Data stored in the DRAM 12 is erased by turning off a power supply.

The network control unit 21 exchanges information via a network such as the Internet. The HDD 20 is a nonvolatile storage medium set in the inside of the MFP 201. Data stored in the HDD 20 is not erased even if the power supply is turned off.

The image processing ASIC 22 applies image processing such as gradation correction and color conversion to a scanned image. The page memory 23 stores an image for each page to be printed.

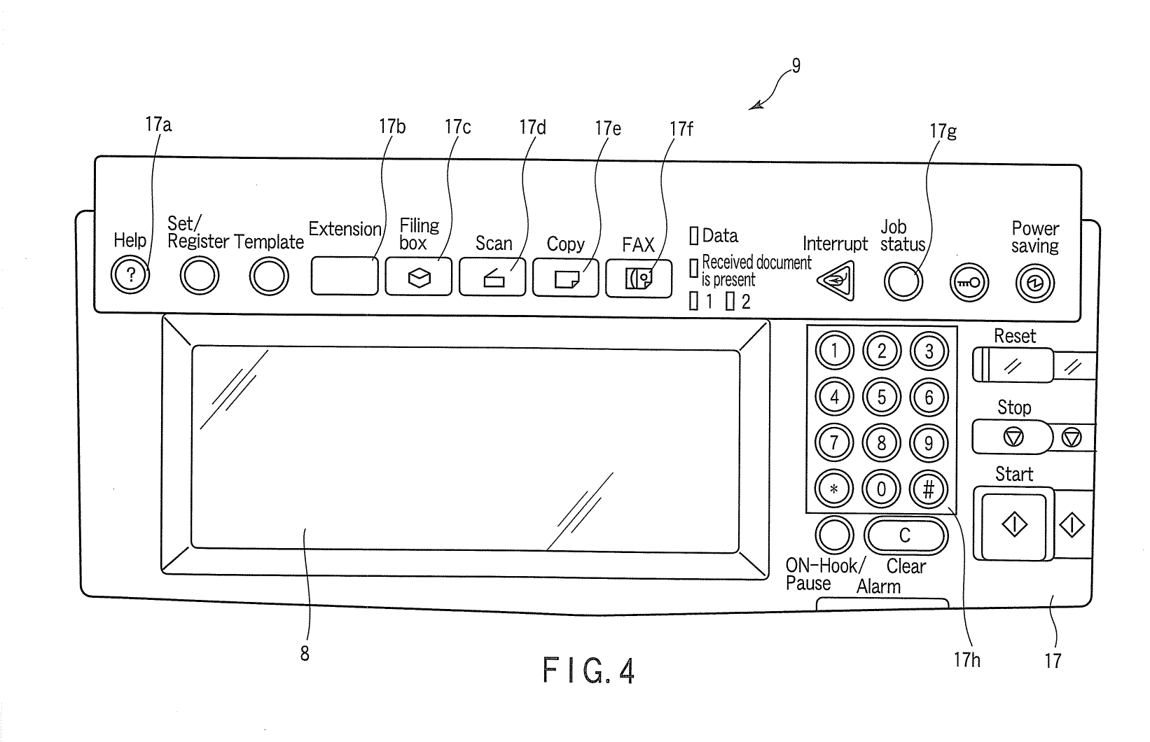

FIG. 4 is an exemplary external view of the operation panel 9 provided in the MFP 201 according to this embodiment. A user performs setting and check of the MFP 201 via the operation panel 9. The operation panel 9 includes the display unit 8 and an operation unit 17. The display unit 8 includes a touch panel. A state of the MFP 201, an operation procedure, various instructions to the user, and the like are displayed on the display unit 8. Various operation buttons for operating the MFP 201 are provided on the operation unit 17.

As keys for invoking screens for selecting and setting functions, a help button 17a, a function extension (extension) button 17b, a filing box button 17c, a scan button 17d, a copy button 17e, a facsimile button 17f, a state check button 17g, and the like are arranged on the operation unit 17. Besides, number keys 17h and the like for setting value input and information check are arranged.

Functions of main buttons among these operation buttons are explained. The user uses the help button 17a in inquiring, for example, what kind of an operation the user should perform next. The user operates the extension button 17b in using extended functions. The user uses the filing box button 17c in extracting stored image data. The user uses the scan button 17d in using a scan function. The user uses the copy button 17e in using a copy function. The user uses the facsimile button 17f in using a facsimile function. The user uses the state check button 17g in executing private printing. The user uses the ten keys 17h in inputting numbers.

A copy control operation of the MFP 201 is explained below.

When the user performs copying, the user sets an original document in the auto feed unit 7 and depresses a start button on the operation panel 9. The control unit 10 controls the scan unit 5 to scan the original document. Image data scanned by the scan unit 5 is transferred to the page memory 23 through the image processing ASIC 22. The image data transferred to the page memory 23 is compressed and stored in the HDD 20.

The control unit 10 extracts the image data from the HDD 20 and expands the image data on the page memory 23. The control unit 10 transfers the expanded data to the print unit 1 and executes printing. Every time each kind of processing related to the copy operation is executed by a task, information related to the operation is collected and stored in the DRAM 12. As explained later, the information related to the operation includes individual information and common information. When an error occurs during the operation, the control unit 10 executes an operation for acquiring information for investigation.

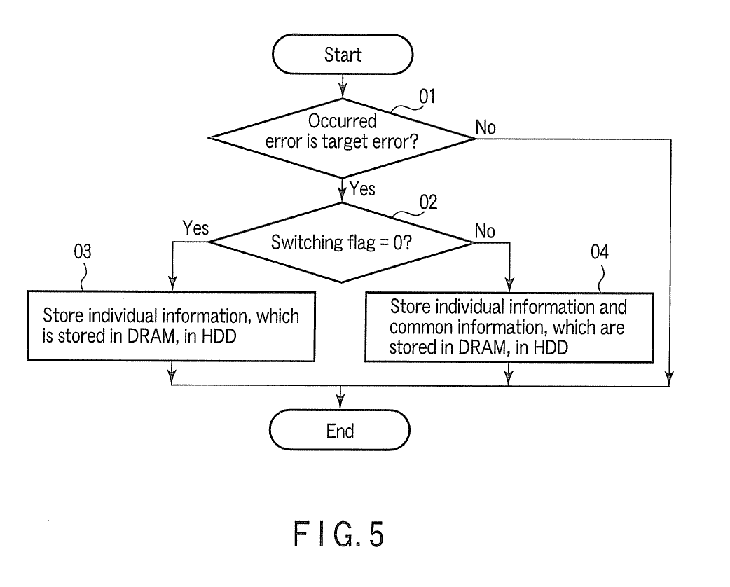

FIG. 5 is an exemplary flowchart for explaining processing for storing the information for investigation acquired when an error occurs according to this embodiment.

In Act 01, the control unit 10 determines whether the occurred error is an error as a target of acquisition of the information for investigation. In this embodiment, the control unit 10 acquires an error ID from an error detection task when the error occurs. The error ID is information for identifying error content. The control unit 10 determines, on the basis of the error ID, whether the occurred error is the target of acquisition of the information for investigation. The error as the target of acquisition of the information for investigation is an error requiring a serviceperson call such as impossibility of a print operation and impossibility of a copy operation. A table associating error IDs and information indicating whether errors are the target of acquisition of the information for investigation may be provided. The control unit 10 may determine, referring to the table, whether the error is the target of acquisition of the information for investigation.

In the case of No in Act 01, i.e., if the occurred error is not the error as the target of acquisition of the information for investigation, the control unit 10 ends the processing. In the case of Yes in Act 01, i.e., if the occurred error is the error as the target of acquisition of the information for investigation, in Act 02, the control unit 10 checks whether a switching flag is 0. The switching flag is used for changing a type of information to be acquired. A serviceperson sets a value in the switching flag in advance.

In the case of Yes in Act 02, i.e., if the switching flag is 0, in Act 03, the control unit 10 stores the individual information, which is stored in the DRAM 12, in the HDD 20. In the case of No in Act 02, i.e., if the switching flag is not 0, in Act 04, the control unit 10 stores the individual information and the common information, which are stored in the DRAM 12, in the HDD 20.

The individual information is information related to an operation of a task being executed. The common information is information related to an operation among tasks being executed.

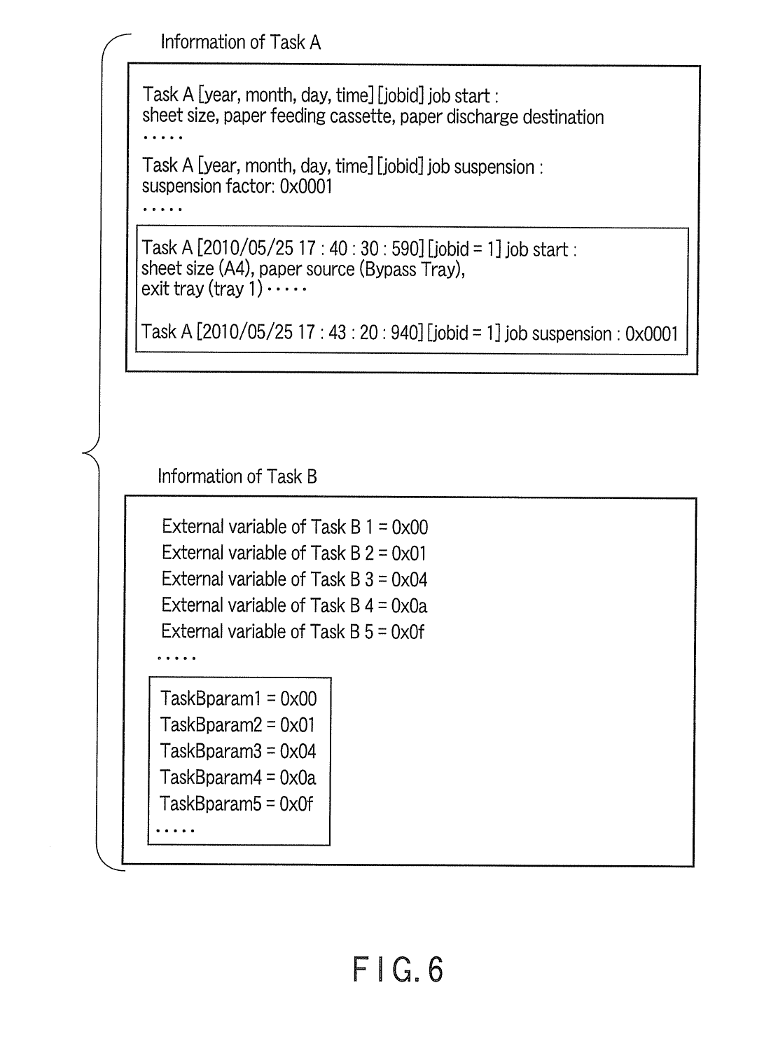

FIG. 6 is an exemplary diagram of contents of the individual information according to this embodiment.

A task A collects, as information related to a copy operation, job start time (2010, May 25, 17:40 . . . ), a sheet size (A4), a paper source (Bypass Tray), an exit tray (a tray 1), job suspension time (2010, May 25, 17:43 . . . ), and the like. A task B collects, as information related to the copy operation, information such as external variables 1 to 5 (0x00, 0x01, 0x04, 0x0a, and 0x0f) and the like.

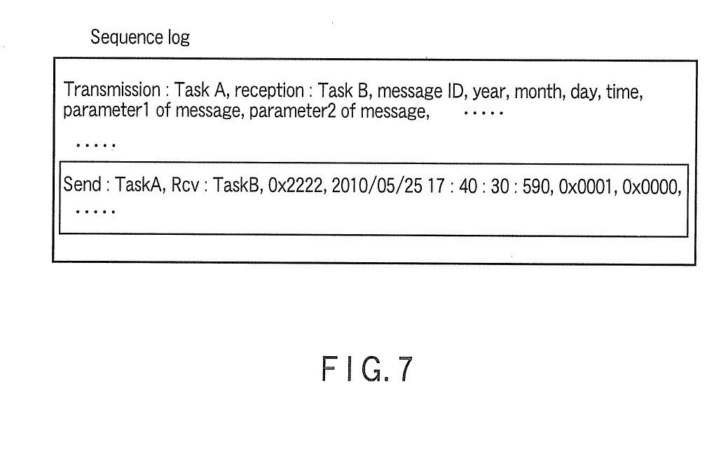

FIG. 7 is an exemplary diagram of contents of common information according to this embodiment.

In a sequence log as the common information, information such as a transmission task (A), a reception task (B), a message ID (0x2222), year, month, day, and time (2010, May 25, 17:40 . . . ), a parameter 1 (0x0001) of a message, and a parameter 2 (0x0000) of the message is collected.

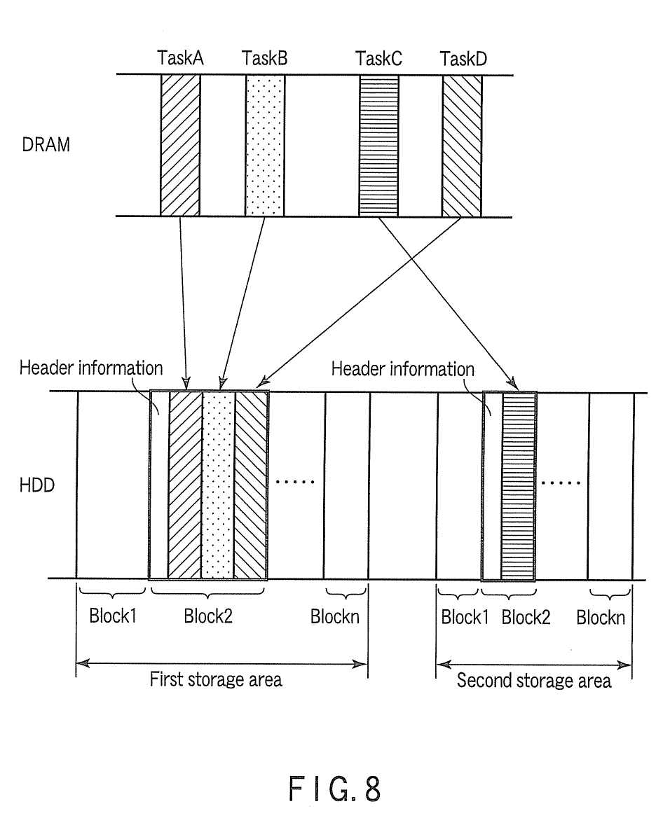

FIG. 8 is an exemplary diagram for explaining an operation for copying information from the DRAM 12 to the HDD 20 according to this embodiment.

Tasks A to D store information in respective areas of the DRAM 12. The tasks A, B, and D stores individual information and the task C stores common information. In copying the information stored in the DRAM 12 to the HDD 20, the control unit 10 collectively stores the individual information in a first storage area of the HDD 20 and collectively stores the common information in a second storage area of the HDD 20. The control unit 10 creates header information including year, month, day, and time of the storage and an error ID and adds the header information to the individual information and the common information.

The first storage area of the HDD 20 includes plural blocks. Every time a processing target error occurs, the control unit 10 sequentially stores the individual information in blocks of the first storage area with the header information collectively added to the individual information. The control unit 10 cyclically uses the first storage area. Specifically, after storing the individual information in the last block, the control unit 10 stores the individual information from the first block. An operation for storing information in the second storage area of the HDD 20 is the same. Therefore, detailed explanation of the operation is omitted.

A method of recovering the information for investigation stored in the HDD 20 as explained above is explained below. The service person recovers the information stored in the HDD 20 when the serviceperson performs failure repair, maintenance, inspection, or the like.

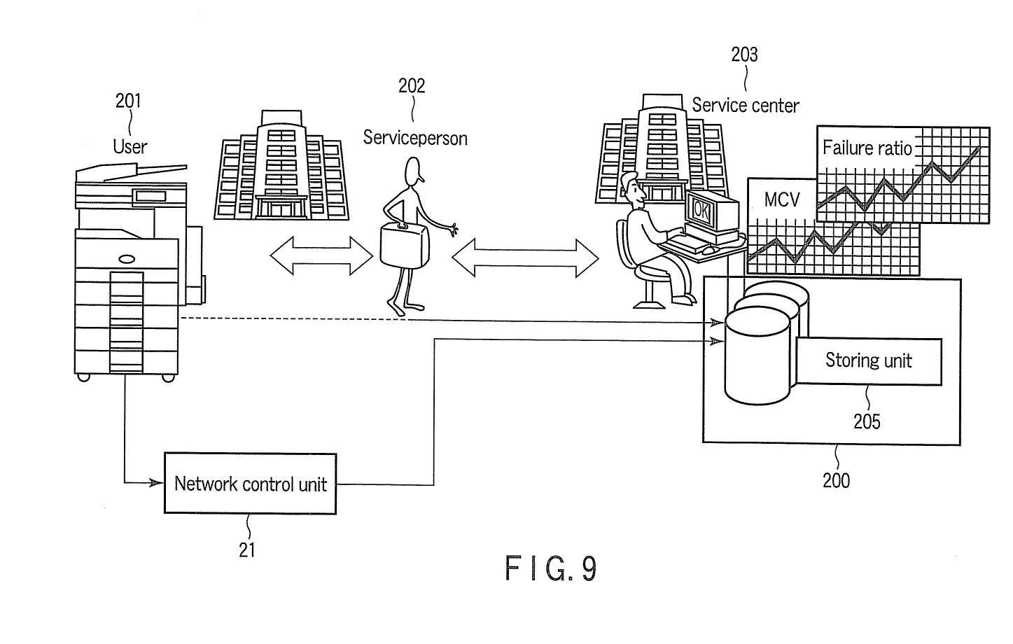

FIG. 9 is an exemplary schematic system diagram of a maintenance method for the MFP 201 according to this embodiment.

Plural servicepersons 202 perform, with one service center 203 as a base, maintenance of plural MFPs 201 set in offices of plural users. A maintenance schedule system 200 is provided in the service center 203.

In general, the maintenance method includes preventive maintenance (PM) and emergency maintenance (EM). In the PM, the serviceperson 202 visits, at periodical timing set for each of the MFPs 201, the user of the maintenance target MFP 201 and performs replacement of consumables, cleaning, and operation check for the MFP 201. In the EM, when a failure accidentally occurs, the serviceperson 202 receives a service call from the user and visits the office of the user to repair the MFP 201.

When the work ends, the serviceperson 202 transmits maintenance history data to the maintenance schedule system 200 provided in the service center 203 via the network control unit 21 of the MFP 201. When the MFP 201 does not have a communication function, the serviceperson 202 inputs, after returning to the service center 203, maintenance history data to the maintenance schedule system 200 from a work record collected as a report of a maintenance job. The maintenance history data is stored in a storing unit 205.

When set periodical communication time (e.g., 10 o'clock every day) comes, the MFP 201 transmits data concerning a state of use to the maintenance schedule system 200. The data concerning the state of use is stored in the storing unit 205.

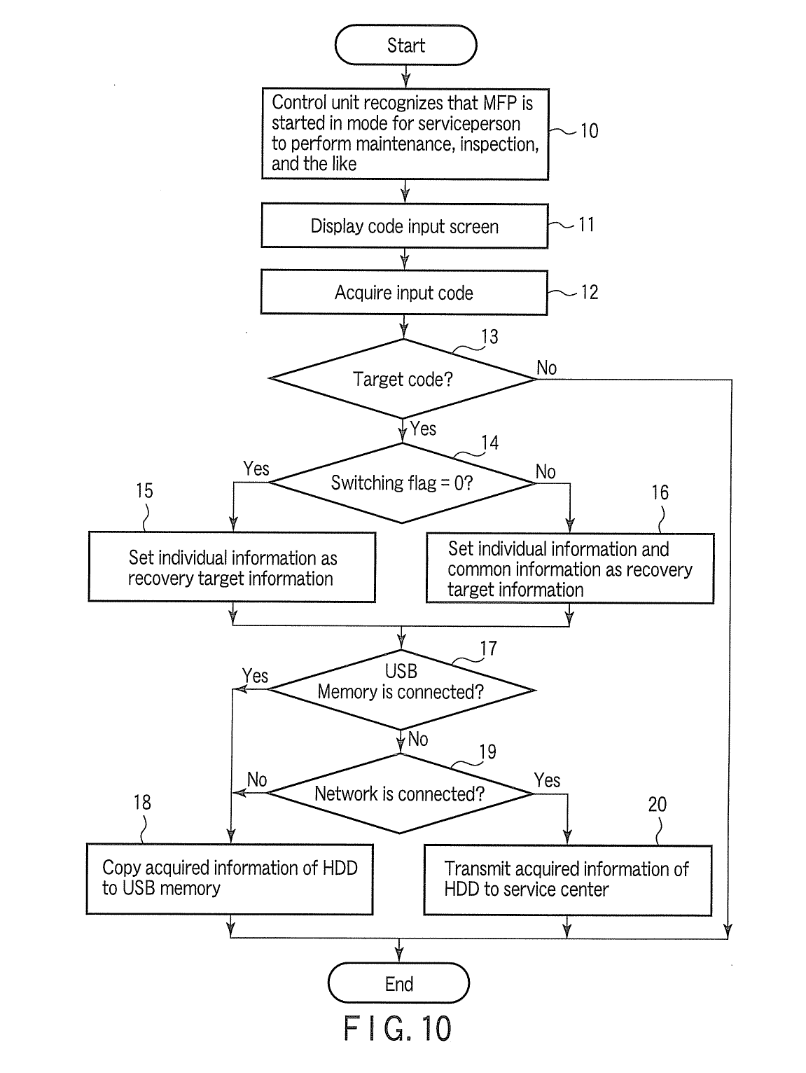

FIG. 10 is an exemplary flowchart for explaining a procedure for the serviceperson 202 to recover the information for investigation stored in the HDD 20 according to this embodiment.

When the serviceperson 202 recovers the information stored in the HDD 20 in the office of the user, the serviceperson 202 starts the MFP 201 in a service mode for the serviceperson to perform maintenance, inspection, and the like. In Act 10, the control unit 10 recognizes that the MFP 201 is started in the service mode. In Act 11, the control unit 10 displays a code input screen 18 on the display unit 8 of the operation panel 9.

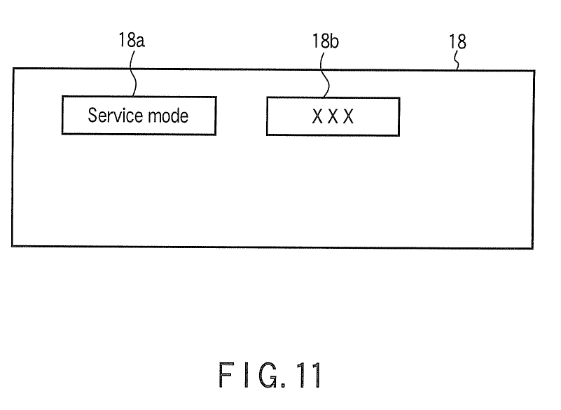

FIG. 11 is an exemplary diagram of the code input screen 18 according to this embodiment. The code input screen 18 includes a mode display space 18a and a code input space 18b. In the mode display space 18a, a message indicating that the MFP 201 is started in the service mode for the serviceperson to perform maintenance, inspection, and the like is displayed. The serviceperson 202 connects a USB (Universal Serial Bus) memory to the MFP 201 and inputs a code to the code input space 18b. The code indicates that the information for investigation stored in the HDD 20 is recovered.

In Act 12, the control unit 10 acquires the input code. In Act 13, the control unit 10 checks whether the code is a code for recovering the information for investigation stored in the HDD 20. In the case of No in Act 13, i.e., if the code is not the code for recovering the information for investigation, the control unit 10 ends the processing.

In the case of Yes in Act 13, i.e., if the code is the code for recovering the information for investigation, in Act 14, the control unit 10 checks a value of the switching flag. In the case of Yes in Act 14, i.e., if the switching flag is 0, in Act 15, the control unit 10 sets the individual information as recovery target information. In the case of No in Act 14, i.e., if the switching flag is not 0, in Act 16, the control unit 10 sets the individual information and the common information as recovery target information.

In Act 17, the control unit 10 checks whether a USB memory is connected to the MFP 201. In the case of Yes in Act 17, i.e., if the USB memory is connected to the MFP 201, in Act 18, the control unit 10 copies the recovery target information to the USB memory and stores the recovery target information in the USB memory. In storing the recovery target information, the control unit 10 copies all data stored in the first storage area or the second storage area to the USB memory.

In the case of No in Act 17, i.e., if the USB memory is not connected to the MFP 201, in Act 19, the control unit 10 checks whether the network to the service center 203 is connected. In the case of No in Act 19, i.e., if the network is not connected, in Act 18, the control unit 10 copies the recovery target information to the USB memory and stores the recovery target information in the USB memory. In the case of Yes in Act 19, i.e., if the network is connected, in Act 20, the control unit 10 transmits the recovery target information to the service center 203.

In this embodiment, the serviceperson 202 inputs, from the operation panel 9, the code for the serviceperson to recover the information for inspection. However, the present invention is not limited to this form. When the control unit 10 recognizes that the MFP 201 is started in the service mode for the serviceperson to perform maintenance, inspection, and the like and the USB memory is connected to the MFP 201, the control unit 10 may automatically copy the recovery target information to the USB memory even if the code is not input.

In this embodiment, the recovery target information is stored in the USB memory. However, the present invention is not limited to this form. When the MFP 201 is connected to a client PC (Personal Computer) via the network, the serviceperson 202 may access the MFP 201 from the client PC and acquire the recovery target information stored in the HDD 20.

In this embodiment, the information to be stored is selected according to the switching flag. However, a value of the switching flag may be associated with an error ID. In other words, the information to be stored may be switched for each of error IDs. The value of the switching flag is not limited to two levels of 0 and 1 and may be values representing plural levels.

The image forming apparatus according to the embodiment explained above realizes a remarkable effect compared with the technique in the past.

The image forming apparatus according to this embodiment automatically stores, when an error occurs, information for a developer to investigate the error in a nonvolatile storage medium. Consequently, even if the power supply is turned off and on or the error is eliminated and the image forming apparatus continues to be used, it is possible to leave information concerning the error.

Since it is possible to select whether the information to be collected is only the individual information or include the common information as well, it is possible to acquire appropriate information corresponding to an error occurrence state. Further, since it is possible to select, for each error, the information to be acquired, it is possible to acquire more appropriate information.

The collection of information can be performed by, besides collection by the USB memory, access from the client PC or transmission to the service center. Therefore, it is possible to acquire information with a reduced burden on the serviceperson.

The functions explained in the embodiment may be configured by using hardware. A computer program describing the functions using software may be realized by causing a computer to read the computer program. The functions may be configured by selecting the software or the hardware as appropriate.

Further, the functions can also be realized by causing the computer to read a computer program stored in a not-shown recording medium. A recording form of the recording medium in this embodiment may be any form as long as the recording medium can record the computer program and is computer-readable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a data collecting unit configured to collect, every time each kind of processing of the apparatus is executed by a task, information related to the processing and store the information in a volatile memory;
an error detecting unit configured to detect an error during the processing;
a determining unit configured to determine whether the error detected by the error detecting unit is an investigation target error;
a target-information selecting unit configured to select, if the determining unit determines that the error is the investigation target error, storage target information out of information for investigation stored in the volatile memory including individual information representing processing content for each of tasks and common information representing processing contents among plural tasks; and
a storing unit configured to copy the selected target information to a nonvolatile memory and store the target information in the nonvolatile memory.

2. The apparatus according to claim 1, wherein the determining unit determines, on the basis of information for identifying an occurred error, whether the occurred error is the investigation target error.

3. The apparatus according to claim 2, wherein the target-information selecting unit determines, on the basis of switching information set in the apparatus in advance, whether the individual information is set as a target of storage or the individual information and the common information are set as targets of storage.

4. The apparatus according to claim 2, wherein the target-information selecting unit determines, on the basis of the information for identifying an occurred error, whether the individual information is set as a target of storage or the individual information and the common information are set as targets of storage.

5. The apparatus according to claim 1, wherein the storing unit aggregates the individual information for each of the tasks and stores the individual information in a first storage area of the nonvolatile memory and stores the common information in a second storage area of the nonvolatile memory.

6. The apparatus according to claim 1, further comprising:
a recovery-target selecting unit configured to select recovery target information out of the information stored in the nonvolatile memory; and
an output unit configured to output the selected recovery target information to an outside.

7. The apparatus according to claim 6, wherein the output unit outputs, when an instruction for outputting the recovery target information to the apparatus is input, the recovery target information to a USB memory connected to the apparatus or an external apparatus connected to the apparatus via a network.

8. The apparatus according to claim 6, wherein the output unit outputs, when a USB memory is connected to the apparatus, the recovery target information to the USB memory connected to the apparatus.

9. A image forming method comprising:
collecting, every time each kind of processing of an image forming apparatus is executed by a task, information related to the processing and storing the information in a volatile memory;
detecting an error during the processing;
determining whether the detected error is an investigation target error;
selecting, if it is determined that the error is the investigation target error, storage target information out of information for investigation stored in the volatile memory including individual information representing processing content for each of tasks and common information representing processing contents among plural tasks; and
copying the selected target information to a nonvolatile memory and storing the target information in the nonvolatile memory.

10. The method according to claim 9, wherein the determining whether the detected error is the investigation target error is determining, on the basis of information for identifying an occurred error, whether the occurred error is the investigation target error.

11. The method according to claim 10, wherein the selecting the storage target information is determining, on the basis of switching information set in the image forming apparatus in advance, whether the individual information is set as a target of storage or the individual information and the common information are set as targets of storage.

12. The method according to claim 10, wherein the selecting the storage target information is determining, on the basis of the information for identifying an occurred error, whether the individual information is set as a target of storage or the individual information and the common information are set as targets of storage.

13. The method according to claim 9, wherein the storing the selected target information in the nonvolatile memory is aggregating the individual information for each of the tasks and storing the individual information in a first storage area of the nonvolatile memory and storing the common information in a second storage area of the nonvolatile memory.

14. The method according to claim 9, further comprising:
selecting recovery target information out of the information stored in the nonvolatile memory; and
outputting the selected recovery target information to an outside.

15. The method according to claim 14, wherein the outputting the recovery target information is outputting, when an instruction for outputting the recovery target information to the image forming apparatus is input, the recovery target information to a USB memory connected to the image forming apparatus or an external apparatus connected to the image forming apparatus via a network.

16. The method according to claim 14, wherein the outputting the recovery target information is outputting, when a USB memory is connected to the image forming apparatus, the recovery target information to the USB memory connected to the apparatus.

17. An image forming apparatus comprising:
data collecting means for collecting, every time each kind of processing of the apparatus is executed by a task, information related to the processing and storing the information in a volatile memory;
error detecting means for detecting an error during the processing;
determining means for determining whether the error detected by the error detecting means is an investigation target error;
target-information selecting means for selecting, if the determining means determines that the error is the investigation target error, storage target information out of information for investigation stored in the volatile memory including individual information representing processing content for each of tasks and common information representing processing contents among plural tasks; and
storing means for copying the selected target information to a nonvolatile memory and storing the target information in the nonvolatile memory.

18. The apparatus according to claim 17, further comprising:
recovery-target selecting means for selecting recovery target information out of the information stored in the nonvolatile memory; and
output means for outputting the selected recovery target information to an outside.
